(19) United States
(12) Patent Application Publication
(10) Pub. No.: US 2026/0228622 A1
(43) Pub. Date: Aug. 6, 2026

(54) DIVERSE PREFERENCE LEARNING WITHOUT REFERENCE MODEL

(71) Applicant: Optum, Inc., Minnetonka, MN (US)

(72) Inventors: Abhijnan NATH, Fort Collins, CO (US); Andrey VOLOZIN, Redmond, WA (US); Galina GRUNIN, Briarcliff Manor, NY (US); Saumajit SAHA, Karnataka (IN); Albert Aristotle NANDA, Karnataka (IN); Rahul BHOTIKA, Bellevue, WA (US)

(21) Appl. No.: 19/328,426

(22) Filed: Sep. 15, 2025

Related U.S. Application Data
(60) Provisional application No. 63/754,749, filed on Feb. 6, 2025.

(51) Int. Cl. G06N 20/00

(52) U.S. Cl. CPC G06N 20/00

(57) ABSTRACT

Various embodiments of the present disclosure provide a diverse preference training framework that improves the functionality of a computer in various aspects. The techniques comprise receiving a training sample that comprises a training context, and a positive sample response and a negative sample response for the training context. The techniques comprise generating, using a positive loss function of the diverse preference training framework, a positive training signal, generating, using a contrastive loss function of the diverse preference training framework, a contrastive training signal, and generating, using a negative loss function of the diverse preference training framework, a negative training signal for the training sample. The techniques comprise generating an aggregated training signal based on the positive training signal, the contrastive training signal, and/or the negative training signal and training, based on the aggregated training signal, a pre-trained language model.

### CROSS REFERENCE TO RELATED APPLICATIONS

This application claims priority to U.S. Provisional Application No. 63/754,749, entitled “DIVERSE PREFERENCE LEARNING WITHOUT A REFERENCE MODEL” and filed Feb. 6, 2025, the entirety of which is incorporated by reference herein for all purposes.

### BACKGROUND

Generalized machine learning models are prevalent across various applications but are often inaccurate for domain-specific tasks that require nuanced and/or more accurate predictions not achievable by a generically trained model. Some approaches for addressing these challenges comprise domain-specific finetuning and preference alignment. Typically, a pre-trained model may be configured for a particular domain by first finetuning the model on a domain-specific dataset and then aligning the finetuned model with a preference dataset. Such approaches require significant amounts of time, processing resources, and memory for storing training datasets. In most traditional preference alignment objectives, reference models (e.g., baseline model used to measure the improvement of a model being trained) are required for preference alignment. Reference model-based approaches require the storage of two separate models during training (e.g., the model being trained, and the baseline model being used for comparison), which make such approaches unusable in resource constrained environments. In addition, both reference model-based and reference model-less approaches to fine-tuning and preference alignment struggle to capture nuanced preferences or require large amounts of carefully labeled training data to model such preferences, which may be unavailable and/or prohibitively expensive for many use cases.

More particularly, these training and preference alignment approaches leverage binary labels to indicate preferred and unpreferred responses for a particular domain. While straightforward to implement, such approaches lack the ability to represent more subtle degrees of preferences, or to capture cases where multiple responses may be acceptable. In some cases, reference model-based implicit rewards may be used to increase the granularity of preference indications. However, reference model-based implicit rewards require the storage and continuous execution of a reference model, which is time consuming, expensive (e.g., in terms of compute and memory), and requires the allocation of significant memory resources. To avoid the expense (e.g., in terms of compute and memory) of reference model-based implicit rewards, reference model-free implicit rewards may be implemented that aim to learn preferences without requiring a separate reference model. However, these techniques are limited in their ability to leverage the full spectrum of preference information available in a preference dataset and they often reduce nuanced feedback to binary labels, discarding potentially valuable signals about relative preference strengths or cases of equal preference.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 is a dataflow diagram of a domain-specific machine learning approach in accordance with some embodiments of the present disclosure.

FIG. 5 is a dataflow diagram of domain-specific training technique for a domain-specific machine learned model in accordance with some embodiments of the present disclosure.

FIG. 6 is a flowchart diagram of an example preference alignment process in accordance with some embodiments of the present disclosure.

### DETAILED DESCRIPTION

Various embodiments of the present disclosure provide machine learning training and alignment techniques that improve the functionality of a computer with respect to domain-specific machine learning tasks. To do so, some embodiments of the present disclosure provide a diverse preference training framework that defines a combination of complementary loss functions and a flexible weighting mechanism to capture diverse preference nuances within a preference dataset, without a reference model. In this manner, the diverse preference training framework provides a reference model-free preference alignment approach that improves the accuracy and usability of domain-specific machine learning models, with respect to a particular domain, and is executable within resource-constrained environments. This, in turn, improves machine learning technology by increasing model accuracy, while enabling the alignment of pretrained models to new use cases, tasks, and domains.

More particularly, the diverse preference training framework defines a combination of complementary loss functions that address technical challenges with traditional preference alignment approaches. For example, the combination of complementary loss functions enables the determination of a holistic loss measure (e.g., aggregated training signal) for a model that simultaneously reduces overfitting to positive and negative samples in contrastive training samples of a preference dataset, while allowing training insights from individual positive sample responses and negative sample responses. Specifically, the combination of complementary loss functions may comprise (1) a positive loss function that mitigates overfitting to negative sample responses and enables learning from individual positive sample responses, (2) a contrastive loss function that incorporates positive sample responses and negative sample responses when available, and/or (3) a negative loss function that mitigates overfitting to positive sample responses and enables learning from individual negative sample responses. In this manner, the diverse preference training framework may integrate a combination of complementary loss functions to overcome degeneracies with traditional preference alignment approaches (e.g., in terms of speed, compute requirements, and accuracy), such as underfitting or overfitting to a preference dataset leading to hallucination-based inaccuracies, among other performance deficiencies experienced by reference model-based and reference model-free preference alignment approaches.

In addition, or alternatively, the diverse preference training framework integrates a flexible weighting mechanism with a combination of complementary loss functions to capture preference nuances unattainable through traditional, reference model-free approaches (and some reference model-based approaches). For example, individual signals of the combination of loss functions within the diverse preference training framework may be offset by sample-specific weights, comprising a positive sample weight, a contrastive sample weight, and negative sample weight, that may modify and/or mask out loss signals based on the relative alignment of a contrastive pair with domain-specific preferences. Although the term signal is used here, that term may be construed to mean a loss, loss function, sub-loss, or sub-loss function. In this way, the flexible weighting mechanism may enable sample-level adjustment to loss signals that may capture nuanced preferences traditionally ignored by reference-free preference alignment approaches. By doing so, the diverse preference training framework improves upon traditional preference training approaches by providing a reference model-free approach (e.g., that improves computational efficiency by reducing storage and processing requirements for a reference model) that captures the granular desirability of samples with less computing resources relative to traditional preference learning approaches. This, in turn, improves the performance (e.g., in terms of accuracy, usability, adaptability) of domain-specific machine learned models, trained using the diverse preference training framework, and allows for the adaptation of traditionally underperforming models to generate more accurate and nuanced responses. Ultimately, this enables improved domain-specific responses that, unlike traditional techniques, may handle diverse preferences without reductions in response quality or the need for extensive reference data.

Examples of technologically advantageous embodiments of the present disclosure comprise an improved training technique that modifies and augments traditional preference alignment approaches to improve machine learning technology among other aspects of the present disclosure. Other technical improvements and advantages may be realized by one of ordinary skill in the art.

### I. OVERVIEW OF EMBODIMENTS

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

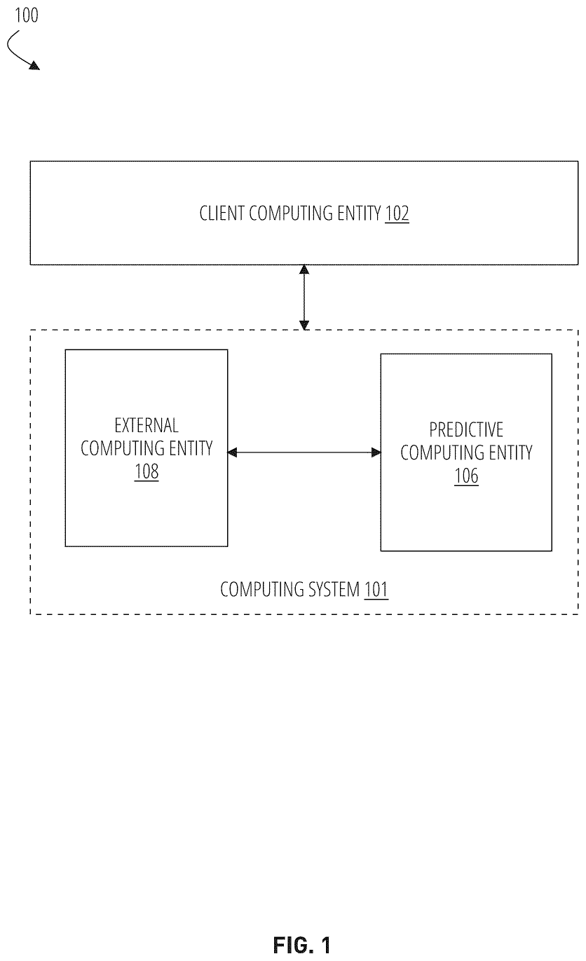

FIG. 1 depicts a block diagram of an example architecture 100 in accordance with some embodiments of the present disclosure. The architecture 100 comprises a computing system 101 configured to receive a request, such as a training request, a model prompt, and/or the like, from client computing entities 102, process the request, and provide the responses, such as a domain-specific response, and/or the like. to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate candidate outputs, candidate output scores, and/or other machine learned outputs. The models may be adapted to a domain and/or the preferences therein using preference training techniques of the present disclosure. In this way, some techniques of the present disclosure may adapt traditional models to a domain-specific framework to improve the performance of the models with respect to a particular domain.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., machine learning training, preference fine tuning, and/or inference techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as preference datasets, and/or the like, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

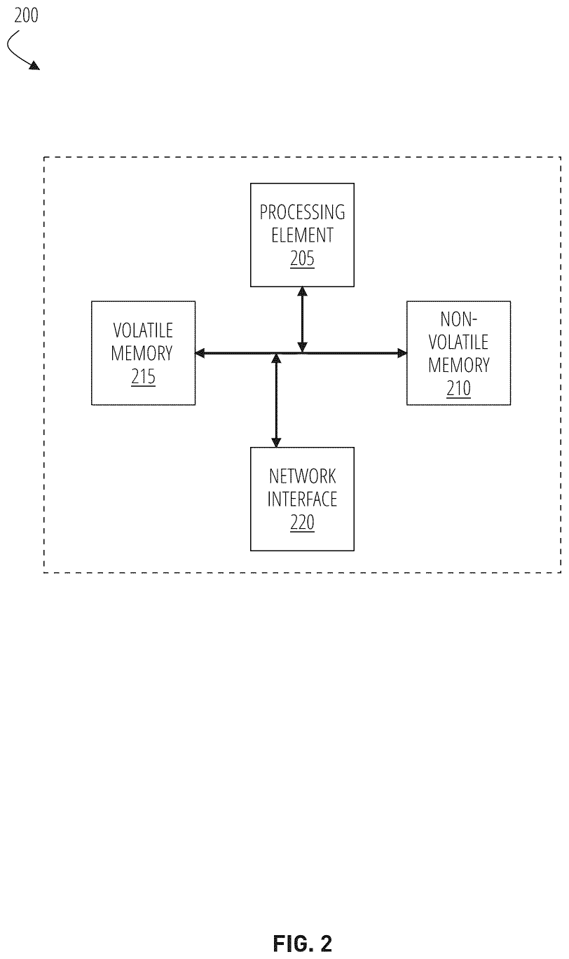

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, comprising as computer program products that comprise articles of manufacture. Such computer program products may comprise one or more software components comprising, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (comprising volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

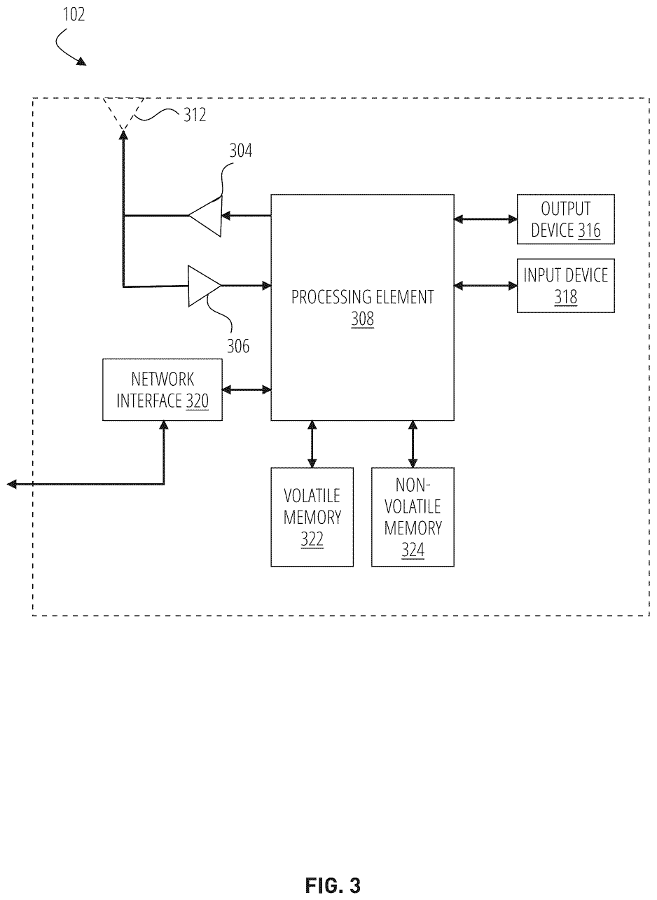

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., comprising executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, comprising Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, comprising cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies comprising RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLE SYSTEM OPERATIONS

As indicated, various embodiments of the present disclosure make important technical contributions to computer functionality, such as machine learning technology. In particular, systems and methods are disclosed herein that implement machine learning model training techniques to improve the performance (e.g., in terms of preference alignment, accuracy) of machine learning model with respect to particular domains, while reducing the resource requirements (e.g., storage requirements, processing resources) relative to traditional training processes. By doing so, the machine learning model training techniques of the present disclosure enable improved preference training approaches that, when executed on a computer, improves the performance of the computer for domain-specific tasks. This, in turn, may improve the functionality of a computer with respect to various computing tasks, comprising data security, machine learning training, network communication, and the like, depending on the domain of interest.

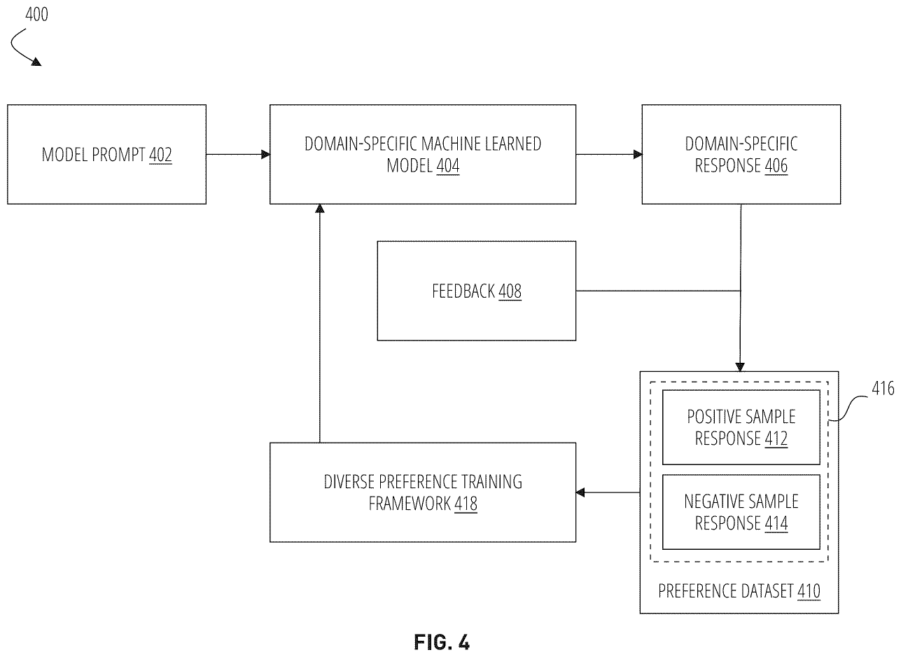

FIG. 4 is a dataflow diagram 400 of a domain-specific machine learning approach in accordance with some embodiments of the present disclosure. A computing system, such as the computing system 101, may execute the domain-specific machine learning approach to generate a domain-specific response 406 to a model prompt 402. To do so, the computing system 101, and/or another system, may train a domain-specific machine learned model 404 using a diverse preference training framework 418. Unlike traditional preference training techniques, the diverse preference training framework 418 may be leveraged to finetune a pre-trained language model for a particular domain (e.g., rather than preferences after the domain-specific training stage). By doing so, in some examples, the domain-specific machine learned model 404 may be trained directly from a preference dataset 410 for a particular domain. In some examples, the domain-specific machine learned model 404 may be continuously refined through feedback 408 for the domain-specific response 406 to improve the domain-specific machine learned model 404 with respect to the domain. For example, and as described further herein, the diverse preference training framework 418 may comprise a reference model-free alignment framework for preference learning, which allows for the continuous training of the domain-specific machine learned model 404 by removing the storage constraints traditionally required for reference model-based approaches. This, in turn, allows for continuous performance improvements (e.g., in terms of accuracy, preference alignment) of the domain-specific machine learned model 404 after the domain-specific machine learned model 404 is initially trained and aligned with preferences within a particular domain.

In some embodiments, the computing system 101 generates, using a domain-specific machine learned model 404, a domain-specific response 406 to a model prompt 402. The domain-specific response 406 may comprise a structured, natural language, and/or any other type of output from a domain-specific machine learned model 404. The output, for example, may be triggered for queries (e.g., a question-answering configuration), tasks (e.g., a summarization task), and/or the like, within the domain-specific machine learned model's 404 trained domain. By way of example, in a clinical domain, the domain-specific response 406 may comprise treatment recommendations and/or instructions, while, in a computer security domain, the domain-specific response 406 may comprise a network security alert and/or mitigation action.

In any domain, the domain-specific response 406 may comprise response from the domain-specific machine learned model 404 that incorporates the preferences learned through a diverse preference training framework 418, as described herein. The domain-specific response 406, for example, may be tailored to a particular domain, task, and/or one or more preferences associated therewith to align the domain-specific response 406 with one or more expectations, requirements, and/or the like within a domain. By way of example, for a summarization task in a clinical domain, the domain-specific response 406 may summarize a clinical document with a specific emphasis on health codes to improve the accuracy and comprehensiveness of the summary for downstream clinical operations. As another example, in a summarization task for a network security domain, the domain-specific response 406 may summarize a network activity log with a specific emphasis on irregularities to improve the conciseness of the summary for downstream computer security operations. In this way, the domain-specific response 406, and/or the attributes thereof, may depend on the domain and/or the requirements of the domain. To improve the accuracy, usability, and reliability of the domain-specific response 406 with respect to a particular domain, the domain-specific response 406 may be generated by a domain-specific machine learned model 404 that is trained using a diverse preference training framework 418 to optimize the domain-specific response 406 relative to the specific characteristics within the particular domain.

In some embodiments, the model prompt 402 is an input for a language model, such as the domain-specific machine learned model 404, that may comprise a set of instructions, a query, and/or other context for creating a generative response. In some examples, the model prompt 402 may be implemented as a sequence of tokens that are processed by the neural network layers of the language model. The tokens may comprise numerical representations of words, subwords, and/or the like that the model may be trained on. For example, model prompt 402 may be encoded into a numerical format before being passed through the model architecture.

The model prompt 402, for example, may comprise a set of instructions and/or context to solicit the domain-specific response 406 from the domain-specific machine learned model 404. For instance, a model prompt 402 may be used to elicit particular types of responses from the domain-specific machine learned model 404. The model prompt 402 may range from a simple query to a complex multi-turn dialogues or task specifications. In some examples, the structure and/or content of the model prompt 402 may help guide the model's generation process. For instance, the model prompt 402 may frame a context and/or desired output for the domain-specific machine learned model 404. To do so, a model prompt 402 may comprise examples, constraints, and/or other guidance to steer the model's generation. In addition, or alternatively, the model prompt 402 may comprise a few-shot prompt where multiple examples may be provided in the model prompt 402, and/or a chain-of-thought prompt that encourages step-by-step reasoning through a series of model prompts 402.

In some embodiments, the domain-specific machine learned model 404 is a machine learned model that is trained, at least in part, using the diverse preference training framework 418 of the present disclosure. The domain-specific machine learned model 404 may comprise a neural network, such as a transformer architecture, recurrent neural network, convolutional neural network, and/or any other machine learning architecture or combinations thereof. In some examples, the domain-specific machine learned model 404 may comprise a language model, such as a large language model, a foundational model, and/or the like, that is trained, finetuned, and/or the like, for a particular domain and/or one or more preferences within the domain. For instance, the domain-specific machine learned model 404 may comprise a pretrained model, such as a generative pre-trained transformer, and/or the like, which is finetuned using a preference dataset 410 to modify its parameters to incorporate domain-specific preferences. In this manner, the domain-specific machine learned model 404 may generate domain-specific responses 406 to model prompts 402 within a particular domain.

In some embodiments, the domain-specific machine learned model 404 is previously trained using a diverse preference training framework 418 and/or a preference dataset 410. In some examples, the domain-specific response 406 may be added, with feedback 408, to the preference dataset 410. The feedback 408, for example, may reflect a relative desirability (e.g., a positive or negative label) of the domain-specific response 406 with respect to a particular domain. By way of example, the feedback 408 may identify a positive and/or negative label for the domain-specific response 406, a desirability indicator, and/or the like. In some examples, the feedback 408 may be determined based on a comparison (e.g., cosine similarity, Levenshtein distance) between the domain-specific response 406 and a domain-specific ground truth for the model prompt 402. In addition, or alternatively, the feedback 408 may comprise user feedback reflective a user's preference towards to the domain-specific response 406.

In some embodiments, the preference dataset 410 comprises a set of labeled model responses from a base model, such a pretrained model, a previous iteration of the domain-specific machine learned model 404, and/or the like, that is generated from a set of training contexts (e.g., a model prompt 402 providing for training purposes). The preference dataset 410, for example, may comprise domain-specific data structure that stores a set of training samples 416 reflective of one or more preferences within a domain. The preference dataset 410 may be implemented as any data format, such as a structured data format (e.g., JSON, CSV), a natural language format, a numerical format, and/or the like. Each training sample 416 may be represented as an entry within a database table, a node within graph data structure, and/or the like.

In some examples, the preference dataset 410 may be implemented to record preferences of a domain within a format that is compatible with the diverse preference training framework 418 of the present disclosure. For example, the preference dataset 410 may comprise a set of labeled responses for up to each of a set of training contexts. In some examples, up to each of the labeled responses may be labeled using reinforcement learning feedback 408 (e.g., reinforcement learning with human in the loop) approaches to form a set of training samples 416. The set of labeled responses may comprise a diverse set of training samples 416 that may capture the nuances of preferred responses within a domain to allows the domain-specific machine learned model 404 to learn fine-grained distinctions and generalize to new inputs. By way of example, each training sample 416 may comprise a training context, one or more sample responses, such as a positive sample response 412 and/or negative sample response 414, and/or a desirability indicator reflective of the accuracy, reliability, and/or usefulness of the sample responses with respect to a particular domain.

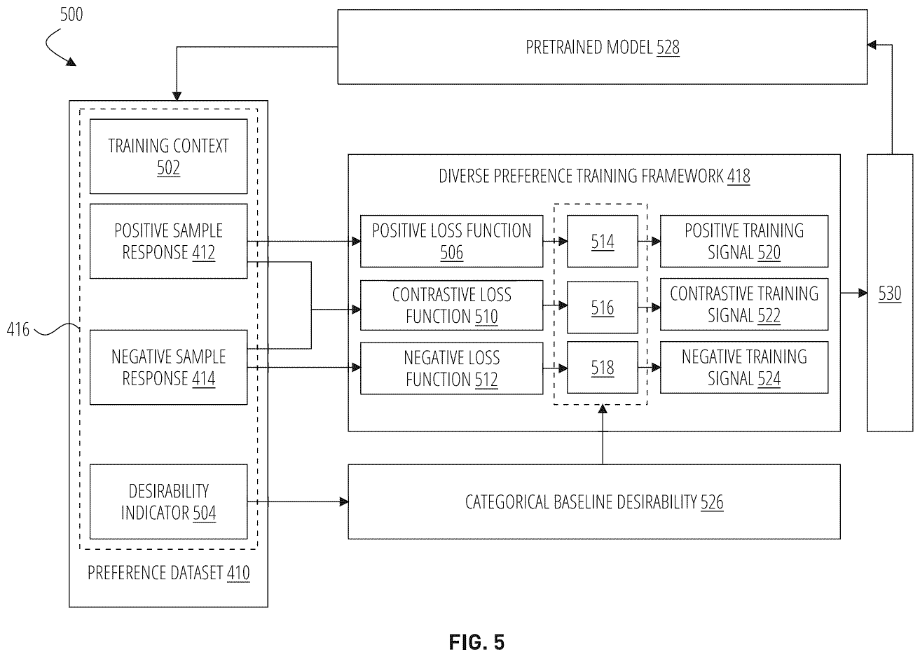

More particularly, a training sample 416 may comprise an entry, node, row, and/or any other data structure within a preference dataset 410. The training sample 416 may comprise a training context 502 (e.g., the model prompt 402 and/or another model prompt) and at least one sample response generated for the training context 502. The at least one sample response may comprise a positive sample response 412 and/or a negative sample response 414 to the training context 502. In this way, a training sample 416 may provide concrete examples of preferred and/or non-preferred outputs for the model that are tailored to a particular domain. As described in further detail with reference to FIG. 5, each training sample 416 may encapsulate a specific instance of the preference learning task, comprising positive and/or negative responses, in the context of a training prompts, and/or one or more desirability indicators reflective of the relative accuracy, reliability, and/or usefulness of the positive and/or negative responses. In this regard, the training context 502 may comprise one or more training prompts that may be provided as input to the domain-specific machine learned model 404. In some examples, the training context 502 may comprise a single prompt. In addition, or alternatively, the training context 502 may comprise a plurality of training prompts that comprise an initial prompt and/or one or more additional prompts within a multi-prompting session with the domain-specific machine learned model 404. In some examples, at least a portion of the plurality of training prompts may be provided to the domain-specific machine learned model 404 as a previous input and/or as part of the context window.

In some embodiments, the diverse preference training framework 418 comprise a reference model-less training framework for optimizing the weights of the domain-specific machine learned model 404 for a particular domain, and/or the preferences therein, using the preference dataset 410. As described with reference to FIG. 5., the diverse preference training framework 418 may define a set of complementary loss functions and a flexible weighting technique for determining a loss that addressed overfitting to both positive and negative sample responses, while incorporating both contrastive and individual, sample-level insights (e.g., positive sample response only insights, negative sample response only insights). By way of example, the set of complementary loss functions may comprise a positive loss function, a contrastive loss function, and/or a negative loss function and the flexible weighting techniques may define positive sample weights, contrastive sample weights, and/or negative sample weights, which may be denoted as:

$${𝔼}_{x , {y}_{w} , {y}_{l} ∼ {D}_{pref}} \{ α \cdot {L}_{SFT} + Υ \cdot log [ σ ( {r}_{odds ( x , {y}_{x} )}^{*} - {r}_{odds ( x , {y}_{l} )}^{*} ) ] + ηlog ( 1 - {π}_{θ} ( {y}_{l} \vert x ) )$$

$$or$$

$${𝔼}_{x , {y}_{w} , {y}_{l} ∼ {D}_{pref}} \{ α \cdot {L}_{SFT} + Υ \cdot log [ σ ( {r}_{norm ( x , {y}_{x} )}^{*} - {r}_{norm ( x , {y}_{l} )}^{*} ) ] + η log ( 1 - {π}_{θ} ( {y}_{l} \vert x ) )$$

according to one or more different variations, where: L_{SFT} is the positive loss function, α is the positive sample weight,

$$log [ σ ( {r}_{odds ( x , {y}_{x} )}^{*} - {r}_{odds ( x , {y}_{l} )}^{*} ) ] and log [ σ ( {r}_{norm ( x , {y}_{x} )}^{*} - {r}_{norm ( x , {y}_{l} )}^{*} ) ]$$

are different variations of example contrastive loss functions, Υ is the contrastive sample weight, log(1−π_{θ}(yₗ|x)) is the negative loss function, and η is the negative sample weight.

Using either variation, the diverse preference training framework 418 may orchestrate the training process for the domain-specific machine learned model 404 that is (a) reference model-free for computational efficiency, (b) learns from pairwise contrastive pairwise data, (c) regularizes to avoid overfitting to positive sample response 412 and negative sample responses 414, (d) incorporates unpaired positive sample response 412 and negative sample responses 414, and (e) offers a flexible weighting scheme to capture the granular desirability of samples when such information is present.

In this manner, and as described in further detail with reference to FIG. 5, the diverse preference training framework 418 may train and/or fine-tune a pre-trained language model to align the model with domain-specific preferences without requiring a separate reference model.

FIG. 5 is a dataflow diagram 500 of domain-specific training technique for a domain-specific machine learned model in accordance with some embodiments of the present disclosure. A computing system, such as the computing system 101, may execute the domain-specific training technique to implement a reference model-free alignment framework that enables policies to capture rich, and often overlooked nuances of domain-specific preferences. To do so, the computing system 101 may execute a diverse preference training framework 418 that defines a set of loss functions for determining a holistic loss measure (e.g., aggregated training signal 530) for a pretrained model 528 that simultaneously reduces overfitting to positive and negative samples in contrastive training samples 416, while allowing training insights from individual positive sample responses 412 and negative sample responses 414. The set of loss functions, for example, may comprise a positive loss function 506 that mitigates overfitting to negative sample responses 414 and enables learning from individual positive sample responses 412, a contrastive loss function 510 that incorporates positive sample responses 412 and negative sample responses 414 when available, and a negative loss function 512 that mitigates overfitting to positive sample responses 412 and enables learning from individual negative sample responses 414. In some examples, the set of loss functions may be offset by sample-specific weights, comprising a positive sample weight 514, a contrastive sample weight 516, and negative sample weight 518, that may modify and/or mask out loss signals based on the relative alignment of a training sample 416 with a domain-specific preference. By doing so, the diverse preference training framework 418 improves upon traditional preference training approaches by providing (a) reference model-free approach (e.g., that improves computational efficiency by reducing storage and processing requirements for a reference model) that (b) learns from contrastive training samples 416, (c) is regularized to avoid overfitting to both positive training signals 508 and negative training signals 524, (d) incorporates positive training signals 508 and negative training signals 524 when available, and (e) offers a flexible weighting scheme to capture the granular desirability of samples.

In some embodiments, the computing system 101 receives from a preference dataset 410, a training sample 416 that comprises a training context 502, a positive sample response 412 for the training context 502, a negative sample response 414 for the training context 502, and/or one or more desirability indicators 504. For example, the training sample 416 may comprise a desirability indicator 504 associated with the positive sample response 412 and/or the negative sample response 414. By way of example, a training sample 416 may be denoted as:
{x,y_{w},yₗ,sᵢⱼ}
where x is the training context 502, y_{w} is the positive sample response 412, yₗ is the negative sample response 414, and sᵢⱼ is the desirability indicators 504 and the preference dataset 410 may be denoted as:

$${D}_{pref} = {\{ x , {y}_{w} , {y}_{l} , {s}_{ij} \}}_{i = 1}^{N} .$$

In some embodiments, the training context 502, denoted as x, is a component of a training sample 416 that elicits one or more positive sample responses 412 and/or negative sample responses 414. The training context 502, for example, may comprise a model prompt that provides an input or scenario that prompts and/or guides a model's generative output. In some examples, the training context 502 may comprise a task-specific set of instructions (e.g., summarization instructions, question-answering instructions) and/or a context corresponding to the set of instructions. The context may be received from one or more datasets, such as a single-turn instruction following dataset, a content summarization dataset, an image annotation dataset, and/or the like. In some examples, up to each of the training contexts 502 may comprise a same or similar set of instructions with a different context to provide diverse and representative examples of the types of inputs for a particular machine learning task within a particular domain.

In some embodiments, the positive sample response 412, denoted as y_{w}, is a component of a training sample 416 that is labeled as a positive example of one or more preferences within a domain. A positive sample response 412, for example, may represent a desirable and/or preferred output for the given training context 502. By way of example, a positive sample response 412 may be used to provide examples of high-quality outputs for a particular domain to guide the pretrained model 528 towards generating responses that align with the desired preferences for the domain. In some examples, the positive sample response 412 may be labeled based on a relative desirability of the positive sample response 412 meeting or exceeding a desirability threshold (e.g., above a 50th percentile within the preference dataset 410)

In some embodiments, the negative sample response 414, denoted as yₗ, is a component of a training sample 416 that is labeled as a negative example of one or more preferences within a domain. A negative sample response 414, for example, may represent an undesirable and/or unpreferred output for the given training context 502. By way of example, a negative sample response 414 may be used to provide examples of low-quality outputs for a particular domain to guide the pretrained model 528 away from generating responses out of alignment with the desired preferences for the domain. In some examples, the negative sample response 414 may be labeled based on a relative desirability of the negative sample response 414 failing to meet a desirability threshold (e.g., below a 50th percentile within the preference dataset 410).

In some embodiments, the desirability indicator 504, denoted as sᵢⱼ, comprises a relative preference tuple with a first preference value, sᵢ, and a second preference value, sⱼ, representing the strength of the relative preference between the positive sample response 412 and the negative sample response 414. For example, the desirability indicator 504 may comprise a scalar, a logit, and/or any other value (e.g., single scalar value, a more complex representation like a vector of scores) that quantifies an improvement of the positive sample response 412 compared to the negative sample response 414 with respect to aligning with one or more preferences within a domain. As described herein, the desirability indicator 504 of a training sample 416 may be used to provide more fine-grained information of preferences beyond binary labels the enable the diverse preference training framework 418 to distinguish between slight preferences and strong preferences during training, which may be captured using the flexible weighting mechanisms of the present disclosure. In some examples, the desirability indicator 504 may comprise a manual annotation. In addition, or alternatively, the desirability indicator 504 may comprise an automated annotation that may be automatically generated using a large language model.

In some embodiments, the computing system 101 generates, using the positive loss function 506 of the diverse preference training framework 418, a positive training signal 520 for the pretrained model 528 based on the positive sample response 412 to the training context 502. For example, the positive loss function 506 may comprise a supervised finetuning loss function. The positive training signal 520 may be based on a comparison between the positive sample response 412 and a labelled response for the training context 502.

More specifically, in some embodiments, the positive loss function 506, denoted as L_{SFT}, comprises a supervised training loss measure, such as a cross-entropy loss that may be applied to all positive sample responses 412 to mitigate overfitting to negative sample responses 414 and/or enable learning from unpaired positive sample responses 412. For example, the positive loss function 506 may measure the cross-entropy between the model's output distribution and a target distribution derived from the ground truth sample. By doing so, the positive loss function 506 allow for training from a training sample 416 even in the absence of a contrastive negative sample response 414.

In some embodiments, the positive training signal 520 comprises a weighted value that is output from the positive loss function 506 and scaled using a positive sample weight 514 to capture granular nuances of the relative preference for a particular positive sample response 412. The positive training signal 520, for example, may represent an individual contribution of the positive sample response 412 to an aggregated training signal 530 of the diverse preference training framework 418. The positive training signal 520 may comprise a scalar, tensor, and/or any other value, computed during each training step to contribute to the aggregated training signal 530, that combines the output of the positive loss function 506 with a weight factor (e.g., positive sample weight 514) that may be adjusted based on the characteristics of the specific training sample 416.

In some embodiments, diverse preference training framework 418 defines a positive sample weight 514 that is applied to the positive training signal 520 to scale the positive training signal 520 based on the desirability indicator 504. More specifically, the positive sample weight 514, denoted as a, comprises a weight that is tunable based on the training sample 416 and applied to a positive training signal 520. By doing so, the positive sample weight 514 may allow for fine-grained control over the importance of up to each positive sample response 412 in the training process. A positive sample weight 514, for example, may be implemented as scalar, and/or any other value, associated with each positive sample in the training data. As described herein, the positive sample weight 514 may be determined for up to each training sample 416 based on a categorical baseline desirability of the training sample 416 to modulate the strength of the learning signal from each positive sample response 412 according to its relative alignment with preferences of a particular domain. This allows the diverse preference training framework 418 to focus more on certain examples, such as those with higher quality, relevance, and/or the like.

In some embodiments, the computing system 101 generates, using the contrastive loss function 510 of the diverse preference training framework 418, a contrastive training signal 522 for the pretrained model 528 based on the positive sample response 412 and the negative sample response 414. In some embodiments, the contrastive loss function 510 comprises a reference model-free implicit reward formulation, such as an odds ratio-based reward formulation and/or a length-normalized reward formulation. The contrastive loss function 510, for example, may assume a uniform prior for the reference model, π_{ref}~ [symbol] ( [symbol] ), to eliminate the need for a reference model in memory. The contrastive loss function 510 may comprise any reference model-free implicit reward formulation, such as the ORPO as described in “ORPO: Monolithic Preference Optimization without Reference Model,” Hong et al. (2023) and/or SimPO as described in “SimPO: Simple Preference Optimization with a Reference-Free Reward,” Meng, et al. (2024).

In some embodiments, the contrastive loss function 510 comprises an odds ratio-based reward signal (e.g., a numerical, probabilistic, or other performance score). The odds ratio-based reward signal, for example, may be denoted as:

$${ref}_{odds ( x , y )}^{*} = β log \frac{{π}_{θ} ( {y}_{w} \vert x )}{1 - {π}_{θ} ( {y}_{w} \vert x )} - β log \frac{{π}_{θ} ( {y}_{l} \vert x )}{1 - {π}_{θ} ( {y}_{l} \vert x )} .$$

In addition, or alternatively, the contrastive loss function 510 may comprise a length-normalized reward signal (e.g., a numerical, probabilistic, or other performance score). The length-normalized reward signal, for example, may be denoted as:

$${ref}_{odds ( x , y )}^{*} = β \frac{log {π}_{θ} ( {y}_{w} \vert x )}{\vert {y}_{w} \vert} - β \frac{log {π}_{θ} ( {y}_{l} \vert x )}{\vert {y}_{l} \vert} .$$

In both variations, β may comprise the KL-beta parameter and |y_{w}| and |yₗ| may comprise the length-normalizations on the likelihood of the positive sample response 412 and the negative sample response 414, respectively. In this way, the complement of the likelihoods in teh denominator of the odds ratio-based reward signal and the length normalization factors of the length-normalized reward signal act as surrogates for a reference model-based regularization. By applying the sigmoid function over both formulations, the preference of y_{w} over yₗ under the Bradley-Terry model may be found as:

$${p}^{*} ( {y}_{w} \text{?} {y}_{l} \vert x = σ ( {r}_{odds ( x , {y}_{x} )}^{*} - {r}_{odds ( x , {y}_{l} )}^{*} )$$

$$and$$

$${p}^{*} ( {y}_{w} \text{?} {y}_{l} \vert x = σ ( {r}_{norm ( x , {y}_{x} )}^{*} - {r}_{norm ( x , {y}_{l} )}^{*} ) ,$$

respectively.

In some embodiments, the contrastive training signal 522 comprises a weighted value that is output from the contrastive loss function 510 and scaled using a contrastive sample weight 516 to capture granular nuances of the relative preference between a positive sample response 412 and a negative sample response 414 of a training sample 416. The contrastive training signal 522, for example, may represent a combined contribution of the positive sample response 412 and the negative sample response 414 to an aggregated training signal 530 of the diverse preference training framework 418. The contrastive training signal 522 may comprise a scalar, tensor, and/or any other value, computed during each training step to contribute to the aggregated training signal 530, that combines the output of the contrastive loss function 510 with a weight factor (e.g., contrastive sample weight 516) that may be adjusted based on the characteristics of the specific training sample 416.

In some embodiments, the diverse preference training framework 418 defines a contrastive sample weight 516 that is applied to the contrastive training signal 522 to scale the contrastive training signal 522 based on the desirability indicator 504. More specifically, the contrastive sample weight 516, denoted as Υ, comprises a weight that is tunable based on the training sample 416 and applied to contrastive training signal 522. By doing so, the contrastive sample weight 516 may allow for fine-grained control over the importance of up to each positive sample response 412 and/or negative sample response 414 in the training process. A contrastive sample weight 516, for example, may be implemented as scalar, and/or any other value, associated with the differences between each contrastive sample pair in the training data. As described herein, the contrastive sample weight 516 may be determined for up to each training sample 416 based on a categorical baseline desirability of the training sample 416 to modulate the strength of the learning signal from a contrastive training signal 522 according to a contrastive pair's relative alignment with preferences of a particular domain. This allows the diverse preference training framework 418 to focus more on divergent examples, such as those with diverging qualities, relevancies, and/or the like.

In some embodiments, the computing system 101 generates, using the negative loss function 512 of the diverse preference training framework 418, a negative training signal 524 for the pretrained model 528 based on the negative sample response 414 to the training context 502. In some examples, the negative loss function 512 measures an unlikelihood of the negative sample response 414. For example, the unlikelihood may comprise a likelihood or posterior probability, indicated as a logit and/or a normalized logit, of a non-occurrence. More specifically, in some embodiments, the negative loss function 512, denoted as log 1−π_{θ}(yₗ|x)), comprises an unlikelihood loss term that prevents overfitting to positive sample responses and enables training from unpaired negative sample responses 414. For instance, the negative loss function 512 may penalizes high probabilities assigned to tokens in the negative sample response 414 by computing the log probability of the negative sample response 414 under the model and maximizing the value. In this manner, the negative loss function 512 may support learning from unpaired negative sample responses 414 by suppressing the likelihood of negative sample responses 414 during alignment. By doing so, the negative loss function 512 may be integrated within the diverse preference training framework 418 to provide a complementary learning signal to the positive loss function 506 and contrastive loss function 510, helping to shape the model's output distribution and avoid overfitting to positive sample responses 412.

In some embodiments, the negative training signal 524 comprises a weighted value that is output from the negative loss function 512 and scaled using a negative sample weight 518 to capture granular nuances of the relative preference against a negative sample response 414. The negative training signal 524, for example, may represent an individual contribution of the negative sample response 414 to an aggregated training signal 530 of the diverse preference training framework 418. The positive sample weight 514 may comprise a scalar, tensor, and/or any other value, computed during each training step to contribute to the aggregated training signal 530, that combines the output of the negative loss function 512 with a weight factor (e.g., negative sample weight 518) that may be adjusted based on the characteristics of the specific training sample 416.

In some embodiments, the diverse preference training framework 418 defines a negative sample weight 518 that is applied to the negative training signal 524 to scale the negative training signal 524 based on the desirability indicator 504. More specifically, the negative sample weight 518, denoted as η, comprises a weight that is tunable based on the training sample 416 and applied to negative training signal 524. By doing so, the negative sample weight 518 may allow for fine-grained control over the importance of up to each negative sample response 414 in the training process. A negative sample weight 518, for example, may be implemented as scalar, and/or any other value, associated with each negative sample in the training data. As described herein, the negative sample weight 518 may be determined for up to each training sample 416 based on a categorical baseline desirability of the training sample 416 to modulate the strength of the learning signal from each negative sample response 414 according to its relative unalignment with preferences of a particular domain. This allows the diverse preference training framework 418 to focus more on certain examples, such as those with low quality, low relevance, and/or the like.

In some embodiments, the computing system 101 determine the positive sample weight 514, the contrastive sample weight 516, and/or the negative sample weight 518 based on the categorical baseline desirability 526 of the training sample 416. For instance, the computing system 101 may determine the categorical baseline desirability 526 based on a ruleset that assigns one or more of a set of categorical baseline desirability labels to the training sample 416. The set of categorical baseline desirability labels, for example, may comprise an acceptable baseline category, a partially-acceptable baseline category, a rejected baseline category, an accepted-rejected baseline category, and/or an equal baseline category.

In some embodiments, a categorical baseline desirability 526 is a categorical value that represents a desirability of both the positive and negative sample responses. The categorical baseline desirability 526, for example, may provide a coarse-grained assessment of the relative quality of a training sample 416. For instance, the categorical baseline desirability 526 may be implemented as an enumerated type, integer value, and/or the like, associated with up to each training sample 416 of the preference dataset 410. The categorical baseline desirability 526 may be used to group sample pairs into broad quality categories. By doing so, the categorical baseline desirability 526 may inform how the samples may be used during alignment, such as by adjusting loss weights, selecting samples for different training phases, and/or the like.

In some examples, the computing system 101 may determining an acceptable baseline category for the training sample 416 responsive to a first determination that the first preference value and/or the second preference value of the relative preference tuple meet or exceed a first threshold. For example, the acceptable baseline category may comprise a first categorical value indicating that the positive sample response 412 and/or the negative sample responses 414 of the training sample 416 are above an acceptable threshold with respect to the preferences within a domain. The acceptable baseline category, for example, may represent high-quality sample pairs where both responses meet a minimum standard of desirability.

The first threshold may be based on the preference dataset 410. For instance, for a single-turn instruction following dataset, the first threshold may be based on one or more model assigned reward estimates. In addition, or alternatively, expert confidence scores, such as edit distance scores, may be used. In such as case, the first threshold may be set to the 66th percentile score of the preference dataset 410.

The computing system 101 may determine a partially-acceptable baseline category for the training sample 416 responsive to a second determination that the first preference value and/or the second preference value (i) meet or exceed a second threshold and/or (ii) fail to meet the first threshold. For example, the partially-acceptable baseline category may comprise a second categorical value indicating that the positive sample response 412 and/or the negative sample response 414 are between an acceptable threshold and an unacceptable threshold. The partially-acceptable baseline category represents sample pairs of moderate quality.

The second threshold may be based on the preference dataset 410. For instance, for a single-turn instruction following dataset, the second threshold may be based on one or more model assigned reward estimates. In addition, or alternatively, expert confidence scores, such as edit distance scores, may be used. In such as case, the second threshold may be set to the 33rd percentile score of the preference dataset 410.

The computing system 101 may determine a rejected baseline category for the training sample 416 responsive to a third determination that the first preference value and/or the second preference value fail to meet the second threshold. For example, the rejected baseline category may comprise a third categorical value indicating that the positive sample response 412 and/or the negative sample responses 414 are below an unacceptable threshold. The rejected baseline category, for example, may represent low-quality sample pairs where neither response meets a minimum standard of desirability.

By way of example, the computing system 101 may determine the categorical baseline desirability 526 by decomposing s_{i,j} into a tuple (sᵢ, sⱼ) such that sᵢ≥sⱼ and partitioning the preference dataset 410 into categories of “acceptable,” “partially-acceptable,” and “rejected,” signifying a decreasing order of baseline desirability. The training samples 416, for example, may be defined as “acceptable” if the first and second tuple scores are greater than or equal to the first threshold (e.g., sᵢ≥Tₐ and sⱼ≥Tₐ), “partially-acceptable” if the first and second tuple scores are between the first and second threshold (e.g., Tₚ≤sᵢ<Tₐ and Tₚ≤sⱼ<Tₐ), and “rejected” if the first and second tuple scores are less than the second threshold (sᵢ<Tₚ and sⱼ<Tₚ), where Tₐ is the first threshold and Tₚ is the second threshold.

In some examples, the computing system 101 determines an accepted-rejected baseline category for the training sample 416 responsive to a fourth determination that the second preference value fails to meet the second threshold, and the first preference value meets or exceeds the first threshold or the second threshold. For example, the accepted-rejected baseline category comprises a fourth categorical value indicating that the positive sample response is acceptable (e.g., in the acceptable baseline category), and the negative sample response is in a lower baseline category (e.g., a partially-acceptable baseline category, or rejected baseline category). The accepted-rejected baseline category represents sample pairs with clear quality distinctions between the positive sample response 412 and negative sample response 414.

In some examples, the computing system 101 determines an equal baseline category for the training sample 416 responsive to a fifth determination that the first preference value and/or second preference value are within a threshold band. For example, the equal baseline category comprises a fifth categorical value indicating that both a positive sample response 412 and a negative sample response 414 are within an acceptable threshold and within a threshold distance from one another. The equal baseline category, for example, may represent high-quality sample pairs where the preference between responses is very slight or nonexistent. The threshold band, for example, may be based on the preference dataset 410. For instance, the threshold band may comprise one or more standard deviations, and/or other statistical measures, from a mean distance between the positive sample response 412 and negative sample response 414 of the preference dataset 410. In addition, or alternatively, the threshold band may comprise a static measure, such as a 2% window, a 0.5 window, and/or the like, depending on the domain.

By way of example, if the lower score, sⱼ does not satisfy the same threshold as y_{w}, then the training sample 416 is assigned to an accepted-rejected category if the sⱼ<Tₚ. In addition, or alternatively, if the scores, sᵢ,sⱼ, are almost equal (sᵢ~sⱼ), indicating no preference, the training sample 416 is assigned to an equal baseline category.

In some embodiments, the computing system 101 generates the positive training signal 520 by applying a positive sample weight 514 to an output of the positive loss function 506 based on the categorical baseline desirability. For example, in response to a first determination of the acceptable baseline category, the computing system 101 may apply the positive sample weight 514 to the positive training signal 520.

In some embodiments, the computing system 101 generates the negative training signal 524 by applying a negative sample weight 518 to an output of the negative loss function 512 based on the categorical baseline desirability. For example, the computing system 101 may apply the negative sample weight 518 to the negative training signal 524 in response to the third determination of the rejected baseline category for the training sample 416. In addition, or alternatively, in response to the fifth determination of the equal baseline category, the computing system 101 may set the negative sample weight 518 to zero and apply the negative sample weight 518 to the negative training signal 524 to mask out the signal.

In some embodiments, the computing system 101 generates the contrastive training signal 522 by applying a contrastive sample weight 516 to an output of the contrastive loss function 510 based on the categorical baseline desirability. For example, the computing system 101 may apply the contrastive sample weight 516 to the contrastive training signal 522 in response to the third determination of the rejected baseline category for the training sample 416. In addition, or alternatively, in response to the fifth determination of the equal baseline category, the computing system 101 may set the contrastive sample weight to zero and apply the contrastive sample weight to the contrastive training signal to mask out the signal.

More particularly, when the categorical baseline desirability 526 is “acceptable,” the computing system 101, in accordance with the diverse preference training framework 418, may increase the weight on the positive training signal 520 with a. In addition, or alternatively, if the complement yₗ is categorized as “rejected”, the computing system 101 may boost the negative training signal 524 with η, while allowing r* to utilize the contrastive training signal 522 weighted by Υ. In addition, or alternatively, if both yₗ and y_{w} are equally good (sᵢ~sⱼ) within the acceptable category, indicating no preference, the computing system 101 may mask out both the contrastive training signal 522 and the negative training signal 524 by setting Υ and η to zero.

In some embodiments, the computing system 101 generates an aggregated training signal 530 based on the positive training signal 520, the contrastive training signal 522, and/or the negative training signal 524. In some embodiments, the aggregated training signal 530 comprises an aggregated loss signal that combines the positive, contrastive, and negative training signals into a single learning objective for updating the model parameters of the pretrained model 528 to align the pretrained model 528 with one or more domain-specific preferences. The aggregated training signal 530, for example, may comprise a scalar value computed by combining the weighted outputs of the positive, contrastive, and negative loss functions. This aggregated training signal 530 may be determined at each training step as part of the model's optimization process. In this manner, the aggregated training signal 530 may a provide a unified learning direction that balances multiple training objectives and allows the pretrained model 528 to simultaneously learn from positive sample responses 412, contrastive preferences between positive sample responses 412 and negative sample responses 414, and/or negative sample responses 414.

More particularly, the computing system 101 may generate the aggregated training signal 530 as a combination (e.g., products) of sample-independent regularization hyperparameters, (e.g., the sample-wise weights α, Υ, and η) reflecting the baseline desirability or relative quality of a training sample 416. A sample efficient way for the domain-specific machine learned model to learn granularity is to use a weighting function that applies regularization dynamically to y_{w} and yₗ based on the distribution of relative preference strengths s_{i,j} provided in D_{pref}. This function, for example may comprise H(D_{pref}):X→(α, Υ, η), which ascertains the relative importance that the domain-specific machine learned model should place on y_{w} and yₗ during alignment. In this manner, the diverse preference training framework 418 may be executed in two phases, a first, two-layered categorization of training samples 416 based on their baseline desirability and relative strengths and a second, weighting phase that uses the categorization to dynamically learn a refined distribution of preferences.

In some embodiments, the computing system 101 trains, based on the aggregated training signal 530, the pre-trained model prompt to generate the domain-specific machine learned model 404 of FIG. 4. By way of example, the computing system 101 may train the aggregated training signal 530, using one or more training techniques, such as backpropagation or errors optimized using gradient descent, and/or any other training technique, to minimize the aggregated training signal 530 of the diverse preference training framework 418. By way of example, the computing system 101 may determine a set of gradients of the aggregated training signal 530 with respect to the model parameters and apply updates to these parameters. In this manner, the computing system 101 may iteratively improve the pretrained model's 528 performance on the preference learning task.

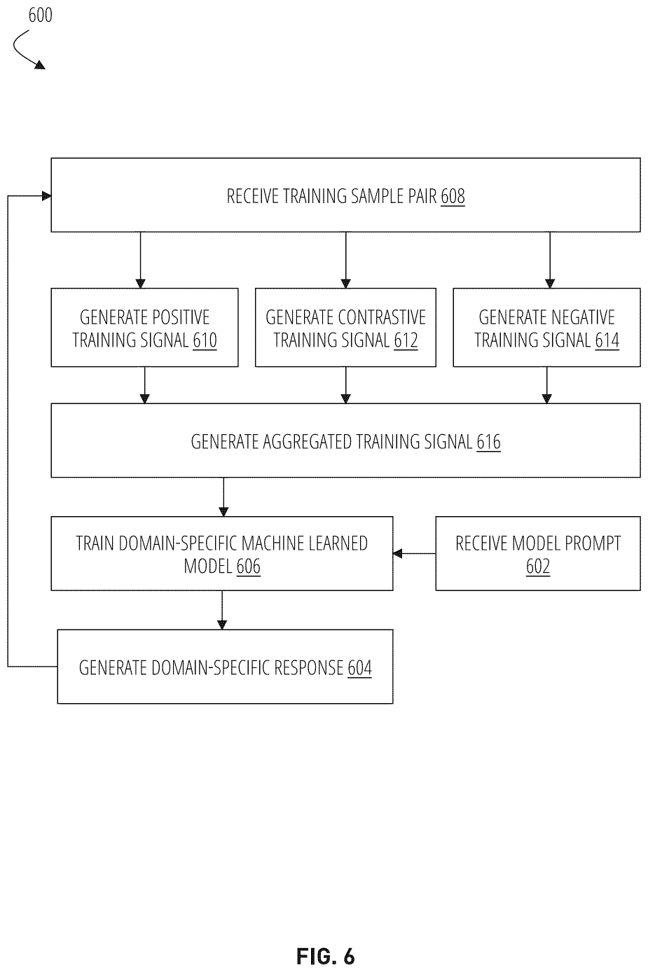

FIG. 6 is a flowchart diagram of an example preference alignment process 600 in accordance with some embodiments of the present disclosure. The flowchart diagram depicts a preference training technique that enables improved preference alignment compared to traditional techniques, while avoiding reference model storage and processing requirements. The process 600 may be implemented by one or more computing devices, entities, and/or systems described herein. For example, via the various steps/operations of the process 600, the computing system 101 may execute a diverse preference training framework to generate a holistic loss signal from contrastive training samples that avoids overfitting to negative and positive samples, while capturing the granular desirability of the samples. By doing so, the process 600 improves computer functionality by improving the preference alignment of preference training tasks at the cost of reduced processing and storage requirements compared to traditional approaches.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 comprises, at operation 602, receiving a model prompt for a domain-specific machine learned model. For example, the computing system 101 may receive the model prompt.

In some embodiments, the process 600 comprises, at operation 604, generating, using a domain-specific machine learned model, a domain-specific response to the model prompt. For example, the computing system 101 may generate, using the domain-specific machine learned model, the domain-specific response to the model prompt. In some examples, the domain-specific response may be added as a portion of a training sample within a preference dataset.

In some embodiments, the process 600 comprises, at operation 606, training the domain-specific machine learned model based on a training sample from a preference dataset. For example, the computing system 101 may train, based on an aggregated training signal, a pre-trained language model to generate the domain-specific machine learned model. The training process, for example, may described with reference to operations 608-616 of the process 600.

In some embodiments, the process 600 comprises, at operation 608, receiving a training sample. For example, the computing system 101 may receive, from a preference dataset, a training sample that comprises a training context, a positive sample response for the training context, and/or a negative sample response for the training context. In some examples, the training sample may comprise a desirability indicator. The desirability indicator, for example, may comprise a relative preference tuple with a first preference value and/or a second preference value.

In some embodiments, the process 600 comprises, at operation 610, generating, using a positive loss function of a diverse preference training framework, a positive training signal for a pre-trained machine learning model based on the positive sample response to the training context. For example, the computing system 101 may generate, using the positive loss function of the diverse preference training framework, the positive training signal for the pre-trained machine learning model based on the positive sample response to the training context. In some examples, the positive loss function comprises a supervised finetuning loss function and/or the positive training signal may be based on a comparison between the positive sample response and a labelled response for the training context.

In some examples, the diverse preference training framework defines a positive sample weight that is applied to the positive training signal to scale the positive training signal based on the desirability indicator. The computing system 101, for example, may determine the positive sample weight based on a categorical baseline desirability of the training sample. For instance, the computing system 101 may determine the categorical baseline desirability by determining an acceptable baseline category for the training sample responsive to a first determination that the first preference value and/or the second preference value of the relative preference tuple meet or exceed a first threshold, determining a partially-acceptable baseline category for the training sample responsive to a second determination that the first preference value and/or the second preference value (i) meet or exceed a second threshold and/or (ii) fail to meet the first threshold, or determining a rejected baseline category for the training sample responsive to a third determination that the first preference value and the second preference value fail to meet the second threshold In some examples, the computing system 101 determines an accepted-rejected baseline category for the training sample responsive to a fourth determination that the second preference value fails to meet the second threshold, and the first preference value meets or exceeds the first threshold or the second threshold. In addition, or alternatively, the computing system 101 determines an equal baseline category for the training sample 416 responsive to a fifth determination that the first preference value and/or second preference value are within a threshold band.

In some embodiments, the process 600 comprises, at operation 612, generating, using a contrastive loss function of the diverse preference training framework, a contrastive training signal for the pre-trained machine learning model based on the positive sample response and the negative sample response. For example, the computing system 101 may generate, using the contrastive loss function of the diverse preference training framework, the contrastive training signal for the pre-trained machine learning model based on the positive sample response and the negative sample response. In some examples, the contrastive loss function 510 comprises an odds ratio-based reward signal and/or a length-normalized reward signal. In some examples, the computing system 101 may apply the positive sample weight to the positive training signal in response to the first determination of an acceptable baseline category for the training sample.

In some examples, the diverse preference training framework defines a contrastive sample weight that is applied to the contrastive training signal to scale the contrastive training signal based on the desirability indicator. The computing system 101, for example, may determine the contrastive sample weight based on the categorical baseline desirability of the training sample. In some examples, the computing system 101 may apply the contrastive sample weight to the contrastive training signal in response to the third determination of the rejected baseline category for the training sample. In addition, or alternatively, in response to the fifth determination of the equal baseline category, the computing system 101 may set the contrastive sample weight to zero and apply the contrastive sample weight to the contrastive training signal to mask out the signal.

In some embodiments, the process 600 comprises, at operation 614, generating, using a negative loss function of the diverse preference training framework, a negative training signal for the pre-trained machine learning model based on the negative sample response to the training context. For example, the computing system 101 may generate, using the negative loss function of the diverse preference training framework, a negative training signal for the pre-trained machine learning model based on the negative sample response to the training context. In some examples, the negative loss function measures an unlikelihood of the negative sample response.

In some examples, the diverse preference training framework defines a negative sample weight that is applied to the negative training signal to scale the negative training signal based on the desirability indicator. The computing system 101, for example, may determine the negative sample weight based on the categorical baseline desirability of the training sample. In some examples, the computing system 101 may apply the negative sample weight to the negative training signal in response to the third determination of the rejected baseline category for the training sample. In addition, or alternatively, in response to the fifth determination of the equal baseline category, the computing system 101 may set the negative sample weight 518 to zero and apply the negative sample weight 518 to the negative training signal 524 to mask out the signal.

In some embodiments, the process 600 comprises, at operation 616, generating an aggregated training signal based on the positive training signal, the contrastive training signal, and/or the negative training signal. For example, the computing system 101 may generate the aggregated training signal based on the positive training signal, the contrastive training signal, and/or the negative training signal.

Some techniques of the present disclosure enable the generation of action outputs that may be performed to initiate one or more real world actions to achieve real-world effects. The techniques of the present disclosure may be used, applied, and/or otherwise leveraged to generate domain-specific outputs for any domain. In some examples, the domain-specific outputs of the present disclosure may trigger action outputs (e.g., through control instructions) to automate robotic actions, computer security actions, clinical actions, and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as comprising logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “comprising,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model comprising one or more supervised, unsupervised, semi-supervised, and/or reinforcement learning models. Training a machine-learned model may comprise altering one or more parameters of the machine-learned model (e.g., using a loss optimization algorithm) to reduce a loss.

Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.
Example 1. A computer-implemented method comprising receiving, from a preference dataset, a training sample that comprises a training context, a positive sample response for the training context, and a negative sample response for the training context, wherein the training context comprises a task-specific set of instructions and a context corresponding to the set of instructions; generating, using a positive loss function of a diverse preference training framework, a positive training signal based on the positive sample response to the training context; generating, using a contrastive loss function of the diverse preference training framework, a contrastive training signal based on the positive sample response and the negative sample response; generating, using a negative loss function of the diverse preference training framework, a negative training signal based on the negative sample response to the training context; generating an aggregated training signal based on the positive training signal, the contrastive training signal, and the negative training signal; training the domain-specific machine learned model based at least in part on altering one or more parameters of the domain-specific machine-learned model based on the aggregated training signal.
Example 2. The computer-implemented method of example 1, wherein the training sample further comprises a desirability indicator associated with the positive sample response and the negative sample response, and the diverse preference training framework generates at least one of (i) a positive sample weight that is applied to the positive training signal to scale the positive training signal based on the desirability indicator, (ii) a contrastive sample weight that is applied to the contrastive training signal to scale the contrastive training signal based on the desirability indicator, or (iii) a negative sample weight that is applied to the negative training signal to scale the negative training signal based on the desirability indicator.
Example 3. The computer-implemented method of example 2, wherein the desirability indicator comprises a relative preference tuple with a first preference value and a second preference value; the positive sample weight, the contrastive sample weight, or the negative sample weight is determined based on a categorical baseline desirability of the training sample; and the categorical baseline desirability is determined based on determining an acceptable baseline category for the training sample responsive to a first determination that the first preference value and the second preference value of the relative preference tuple meet or exceed a first threshold, determining a partially-acceptable baseline category for the training sample responsive to a second determination that the first preference value and the second preference value (i) meet or exceed a second threshold and (ii) fail to meet the first threshold, wherein the second threshold is less than the first threshold, or determining a rejected baseline category for the training sample responsive to a third determination that the first preference value and the second preference value fail to meet the second threshold.
Example 4. The computer-implemented method of example 3, further comprising (i) applying the positive sample weight to the positive training signal in response to the first determination of the acceptable baseline category, or (ii) applying (a) the negative sample weight to the negative training signal and (b) the contrastive sample weight to the contrastive training signal in response to the third determination of the rejected baseline category.
Example 5. The computer-implemented method of example 3 or 4, wherein the categorical baseline desirability of the training sample is further determined by determining an accepted-rejected baseline category for the training sample responsive to a fourth determination that the second preference value fails to meet the second threshold, and the first preference value meets or exceeds the first threshold or the second threshold, or determining an equal baseline category for the training sample responsive to a fifth determination that the first preference value and the second preference value are within a threshold band.
Example 6. The computer-implemented method of example 5, further comprising applying the positive sample weight to the positive training signal in response to the first determination of the acceptable baseline category, and in response to the fifth determination of the equal baseline category, (i) setting the negative sample weight and the contrastive sample weight to zero and (ii) applying (a) the negative sample weight to the negative training signal and (b) the contrastive sample weight to the contrastive training signal.
Example 7. The computer-implemented method of any of the preceding examples, wherein the positive loss function determines the positive training signal based on a difference between the positive sample response and a labelled response for the training context.
Example 8. The computer-implemented method of any of the preceding examples, wherein the contrastive loss function comprises at least one of an odds ratio-based reward signal or a length-normalized reward signal.
Example 9. The computer-implemented method of example 1, wherein the negative loss function measures an unlikelihood of the negative sample response.
Example 10. The computer-implemented method of any of the preceding examples, further comprising generating, using the domain-specific machine learned model, a domain-specific response to a model prompt
Example 11. A system comprising one or more processors; and one or more memories storing processor-executable instructions that, when executed by the one or more processors, cause the one or more processors to perform operations comprising receiving, from a preference dataset, a training sample that comprises a training context, a positive sample response for the training context, and a negative sample response for the training context; generating, using a positive loss function of a diverse preference training framework, a positive training signal based on the positive sample response to the training context; generating, using a contrastive loss function of the diverse preference training framework, a contrastive training signal based on the positive sample response and the negative sample response; generating, using a negative loss function of the diverse preference training framework, a negative training signal based on the negative sample response to the training context; generating an aggregated training signal based on the positive training signal, the contrastive training signal, and the negative training signal; training the domain-specific machine learned model based at least in part on altering one or more parameters of the domain-specific machine-learned model based on the aggregated training signal.
Example 12. The system of example 11, wherein the training sample further comprises a desirability indicator associated with the positive sample response and the negative sample response, and the diverse preference training framework defines at least one of (i) a positive sample weight that is applied to the positive training signal to scale the positive training signal based on the desirability indicator, (ii) a contrastive sample weight that is applied to the contrastive training signal to scale the contrastive training signal based on the desirability indicator, or (iii) a negative sample weight that is applied to the negative training signal to scale the negative training signal based on the desirability indicator.
Example 13. The system of example 12, wherein the desirability indicator comprises a relative preference tuple with a first preference value and a second preference value, and the positive sample weight, the contrastive sample weight, or the negative sample weight is determined based on a categorical baseline desirability of the training sample; and the categorical baseline desirability is determined based on determining an acceptable baseline category for the training sample responsive to a first determination that the first preference value and the second preference value of the relative preference tuple meet or exceed a first threshold, determining a partially-acceptable baseline category for the training sample responsive to a second determination that the first preference value and the second preference value (i) meet or exceed a second threshold and (ii) fail to meet the first threshold, wherein the second threshold is less than the first threshold, or determining a rejected baseline category for the training sample responsive to a third determination that the first preference value and the second preference value fail to meet the second threshold.
Example 14. The system of example 13, wherein the operations further comprise (i) applying the positive sample weight to the positive training signal in response to the first determination of the acceptable baseline category, or (ii) applying (a) the negative sample weight to the negative training signal and (b) the contrastive sample weight to the contrastive training signal in response to the third determination of the rejected baseline category.
Example 15. The system of example 13 or 14, wherein the categorical baseline desirability of the training sample is further determined by determining an accepted-rejected baseline category for the training sample responsive to a fourth determination that the second preference value fails to meet the second threshold, and the first preference value meets or exceeds the first threshold or the second threshold, or determining an equal baseline category for the training sample responsive to a fifth determination that the first preference value and the second preference value are within a threshold band.
Example 16. The system of example 15, wherein the operations further comprise applying the positive sample weight to the positive training signal in response to the first determination of the acceptable baseline category, and in response to the fifth determination of the equal baseline category, (i) setting the negative sample weight and the contrastive sample weight to zero and (ii) applying (a) the negative sample weight to the negative training signal and (b) the contrastive sample weight to the contrastive training signal.
Example 17. One or more non-transitory computer-readable media storing processor-executable instructions that, when executed by one or more processors, cause the one or more processors to perform operations comprising receiving, from a preference dataset, a training sample that comprises a training context, a positive sample response for the training context, and a negative sample response for the training context; generating, using a positive loss function of a diverse preference training framework, a positive training signal based on the positive sample response to the training context; generating, using a contrastive loss function of the diverse preference training framework, a contrastive training signal based on the positive sample response and the negative sample response; generating, using a negative loss function of the diverse preference training framework, a negative training signal based on the negative sample response to the training context; generating an aggregated training signal based on the positive training signal, the contrastive training signal, and the negative training signal; training the domain-specific machine learned model based at least in part on altering one or more parameters of the domain-specific machine-learned model based on the aggregated training signal.
Example 18. The one or more non-transitory computer-readable media of example 17, wherein the positive loss function determines the positive training signal based on a difference between the positive sample response and a labelled response for the training context.
Example 19. The one or more non-transitory computer-readable media of example 17 or 18, wherein the contrastive loss function comprises at least one of an odds ratio-based reward signal or a length-normalized reward signal.
Example 20. The one or more non-transitory computer-readable media of any of examples 17 through 20, wherein the negative loss function measures an unlikelihood of the negative sample response.
Example 21. The computer-implemented method of example 1, wherein the training is performed by the one or more processors.
Example 22. The computer-implemented method of example 21, wherein the one or more processors are comprised in a first computing entity; and the training is performed by one or more other processors comprised in a second computing entity.
Example 23. The computing system of example 11, wherein the one or more processors are further configured to train the domain-specific machine learned model.
Example 24. The computing system of example 23, wherein the one or more processors are comprised in a first computing entity; and the domain-specific machine learned model is trained by one or more other processors comprised in a second computing entity.
Example 25. The one or more non-transitory computer-readable storage media of example 17, wherein the instructions further cause the one or more processors to train the domain-specific machine learned model.
Example 26. The one or more non-transitory computer-readable storage media of example 26, wherein the one or more processors are comprised in a first computing entity; and the domain-specific machine learned model is trained by one or more other processors comprised in a second computing entity.

What is claimed is:

1. A computer-implemented method comprising:
receiving, from a preference dataset, a training sample that comprises a training context, a positive sample response for the training context, and a negative sample response for the training context, wherein the training context comprises a task-specific set of instructions and a context corresponding to the task-specific set of instructions;
generating, using a positive loss function of a diverse preference training framework, a positive training signal based on the positive sample response to the training context;
generating, using a contrastive loss function of the diverse preference training framework, a contrastive training signal based on the positive sample response and the negative sample response;
generating, using a negative loss function of the diverse preference training framework, a negative training signal based on the negative sample response to the training context;
generating an aggregated training signal based on the positive training signal, the contrastive training signal, and the negative training signal;
training a domain-specific machine learned model based at least in part on altering one or more parameters of the domain-specific machine-learned model based on the aggregated training signal.

2. The computer-implemented method of claim 1, wherein the training sample further comprises a desirability indicator associated with the positive sample response and the negative sample response, and the diverse preference training framework generates at least one of:
(i) a positive sample weight that is applied to the positive training signal to scale the positive training signal based on the desirability indicator,
(ii) a contrastive sample weight that is applied to the contrastive training signal to scale the contrastive training signal based on the desirability indicator, or
(iii) a negative sample weight that is applied to the negative training signal to scale the negative training signal based on the desirability indicator.

3. The computer-implemented method of claim 2, wherein:
the desirability indicator comprises a relative preference tuple with a first preference value and a second preference value;
the positive sample weight, the contrastive sample weight, or the negative sample weight is determined based on a categorical baseline desirability of the training sample; and
the categorical baseline desirability is determined based on:
determining an acceptable baseline category for the training sample responsive to a first determination that the first preference value and the second preference value of the relative preference tuple meet or exceed a first threshold,
determining a partially-acceptable baseline category for the training sample responsive to a second determination that the first preference value and the second preference value (i) meet or exceed a second threshold and (ii) fail to meet the first threshold, wherein the second threshold is less than the first threshold, or
determining a rejected baseline category for the training sample responsive to a third determination that the first preference value and the second preference value fail to meet the second threshold.

4. The computer-implemented method of claim 3, further comprising:
(i) applying the positive sample weight to the positive training signal in response to the first determination of the acceptable baseline category, or
(ii) applying (a) the negative sample weight to the negative training signal and (b) the contrastive sample weight to the contrastive training signal in response to the third determination of the rejected baseline category.

5. The computer-implemented method of claim 3, wherein the categorical baseline desirability of the training sample is further determined by:
determining an accepted-rejected baseline category for the training sample responsive to a fourth determination that the second preference value fails to meet the second threshold, and the first preference value meets or exceeds the first threshold or the second threshold, or
determining an equal baseline category for the training sample responsive to a fifth determination that the first preference value and the second preference value are within a threshold band.

6. The computer-implemented method of claim 5, further comprising:
applying the positive sample weight to the positive training signal in response to the first determination of the acceptable baseline category, and
in response to the fifth determination of the equal baseline category, (i) setting the negative sample weight and the contrastive sample weight to zero and (ii) applying (a) the negative sample weight to the negative training signal and (b) the contrastive sample weight to the contrastive training signal.

7. The computer-implemented method of claim 1, wherein the positive loss function determines the positive training signal based on a difference between the positive sample response and a labelled response for the training context.

8. The computer-implemented method of claim 1, wherein the contrastive loss function comprises at least one of an odds ratio-based reward signal or a length-normalized reward signal.

9. The computer-implemented method of claim 1, wherein the negative loss function measures an unlikelihood of the negative sample response.

10. The computer-implemented method of claim 1, further comprising generating, using the domain-specific machine learned model, a domain-specific response to a model prompt.

11. A system comprising:
one or more processors; and
one or more memories storing processor-executable instructions that, when executed by the one or more processors, cause the one or more processors to perform operations comprising:
receiving, from a preference dataset, a training sample that comprises a training context, a positive sample response for the training context, and a negative sample response for the training context;
generating, using a positive loss function of a diverse preference training framework, a positive training signal based on the positive sample response to the training context;
generating, using a contrastive loss function of the diverse preference training framework, a contrastive training signal based on the positive sample response and the negative sample response;
generating, using a negative loss function of the diverse preference training framework, a negative training signal based on the negative sample response to the training context;
generating an aggregated training signal based on the positive training signal, the contrastive training signal, and the negative training signal;
training a domain-specific machine learned model based at least in part on altering one or more parameters of the domain-specific machine-learned model based on the aggregated training signal.

12. The system of claim 11, wherein the training sample further comprises a desirability indicator associated with the positive sample response and the negative sample response, and the diverse preference training framework defines at least one of:
(i) a positive sample weight that is applied to the positive training signal to scale the positive training signal based on the desirability indicator,
(ii) a contrastive sample weight that is applied to the contrastive training signal to scale the contrastive training signal based on the desirability indicator, or
(iii) a negative sample weight that is applied to the negative training signal to scale the negative training signal based on the desirability indicator.

13. The system of claim 12, wherein the desirability indicator comprises a relative preference tuple with a first preference value and a second preference value, and the positive sample weight, the contrastive sample weight, or the negative sample weight is determined based on a categorical baseline desirability of the training sample; and the categorical baseline desirability is determined based on:
determining an acceptable baseline category for the training sample responsive to a first determination that the first preference value and the second preference value of the relative preference tuple meet or exceed a first threshold,
determining a partially-acceptable baseline category for the training sample responsive to a second determination that the first preference value and the second preference value (i) meet or exceed a second threshold and (ii) fail to meet the first threshold, wherein the second threshold is less than the first threshold, or
determining a rejected baseline category for the training sample responsive to a third determination that the first preference value and the second preference value fail to meet the second threshold.

14. The system of claim 13, wherein the operations further comprise:
(i) applying the positive sample weight to the positive training signal in response to the first determination of the acceptable baseline category, or
(ii) applying (a) the negative sample weight to the negative training signal and (b) the contrastive sample weight to the contrastive training signal in response to the third determination of the rejected baseline category.

15. The system of claim 13, wherein the categorical baseline desirability of the training sample is further determined by:
determining an accepted-rejected baseline category for the training sample responsive to a fourth determination that the second preference value fails to meet the second threshold, and the first preference value meets or exceeds the first threshold or the second threshold, or
determining an equal baseline category for the training sample responsive to a fifth determination that the first preference value and the second preference value are within a threshold band.

16. The system of claim 15, wherein the operations further comprise:
applying the positive sample weight to the positive training signal in response to the first determination of the acceptable baseline category, and
in response to the fifth determination of the equal baseline category, (i) setting the negative sample weight and the contrastive sample weight to zero and (ii) applying (a) the negative sample weight to the negative training signal and (b) the contrastive sample weight to the contrastive training signal.

17. One or more non-transitory computer-readable media storing processor-executable instructions that, when executed by one or more processors, cause the one or more processors to perform operations comprising:
receiving, from a preference dataset, a training sample that comprises a training context, a positive sample response for the training context, and a negative sample response for the training context;
generating, using a positive loss function of a diverse preference training framework, a positive training signal based on the positive sample response to the training context;
generating, using a contrastive loss function of the diverse preference training framework, a contrastive training signal based on the positive sample response and the negative sample response;
generating, using a negative loss function of the diverse preference training framework, a negative training signal based on the negative sample response to the training context;
generating an aggregated training signal based on the positive training signal, the contrastive training signal, and the negative training signal;
training a domain-specific machine learned model based at least in part on altering one or more parameters of the domain-specific machine-learned model based on the aggregated training signal.

18. The one or more non-transitory computer-readable media of claim 17, wherein the positive loss function determines the positive training signal based on a difference between the positive sample response and a labelled response for the training context.

19. The one or more non-transitory computer-readable media of claim 17, wherein the contrastive loss function comprises at least one of an odds ratio-based reward signal or a length-normalized reward signal.

20. The one or more non-transitory computer-readable media of claim 17, wherein the negative loss function measures an unlikelihood of the negative sample response.
